(19) United States
(12) Patent Application Publication
(10) Pub. No.: US 2026/0255126 A1
(43) Pub. Date: Aug. 27, 2026

(54) DISPLAY DEVICE AND AUDIO SIGNAL PROCESSING METHOD THEREOF

(71) Applicant: LG ELECTRONICS INC., Seoul (KR)

(72) Inventors: Jong Ha PARK, Seoul (KR); Sang Keun LEE, Seoul (KR); Gen Moo SONG, Seoul (KR); Jin Young KIM, Seoul (KR)

(73) Assignee: LG ELECTRONICS INC., Seoul (KR)

(21) Appl. No.: 19/144,915

(22) PCT Filed: Jan. 2, 2023
(86) PCT No.: PCT/KR2023/000044

§ 371 Date: Jun. 30, 2025

(51) Int. Cl. H04S 7/00; H04S 3/00

(52) U.S. Cl. CPC H04S 7/307; H04S 3/008; H04R 2499/15; H04S 2400/01

(57) ABSTRACT

The present disclosure relates to a display device capable of producing stereophonic sound in conjunction with an audio device, and an audio signal processing method thereof, which may: control, upon input of original audio signals to be played, the original audio signals to be output from an external audio device; input audio signals of a specific frequency band, from among the original audio signals, to a pre-trained neural network model and up-mix same into virtual multi-channel audio signals; and control the up-mixed virtual multi-channel audio signals to be output from an audio output unit.

### TECHNICAL FIELD

The present disclosure relates to a display device capable of implementing three-dimensional sound quality linked to an audio device, and a method for processing an audio signal thereof.

### BACKGROUND ART

In general, a display device is a device that has the function of receiving, processing, and displaying images that can be viewed by a user. A display device receives a broadcast signal selected by a user from among broadcast signals transmitted from a broadcasting station, separates an image signal from the received signal, and then displays the separated image signal on a display.

In recent years, due to the development of broadcasting technology and network technology, the functions of display devices have become considerably more diverse, and the performance of the devices has also improved accordingly. In other words, display devices have evolved to provide users with not only simply broadcasted content, but also various other content.

For example, the display device can provide not only programs received from broadcasting stations, but also game play, music appreciation, Internet shopping, and customized information using various applications. In order to perform these expanded functions, the display device is basically connected to other devices or networks using various communication protocols, and can provide a ubiquitous computing environment to the user. In other words, the display device has evolved into a smart device that enables connectivity to a network and ubiquitous computing.

Meanwhile, the display device can provide three-dimensional sound quality by being connected to an audio device, such as a sound bar, and outputting sound simultaneously with the audio device.

Here, the display device outputs sound through surround speaker channels, rear speaker channels, and height speaker channels when playing multi-channel content, and controls the output of main sound from an audio device connected to the communication.

However, since the audio signals output from the surround speaker channels, rear speaker channels, and height speaker channels of the display device and the audio signals output from the surround speaker channels, rear speaker channels, and height speaker channels of the audio device are identical, there was a problem in which the sound of the display device and the sound of the audio device are overlapped and interfered with each other, resulting in distortion.

In particular, when playing mid-range and low-range sounds, there was a problem of increased sound distortion due to sound interference between the display device and audio device.

Therefore, in the future, it is necessary to develop a display device that can process audio signals to minimize sound interference with audio devices and implement three-dimensional and clear sound quality even when reproducing mid- and low-frequency sounds.

### DISCLOSURE

### Technical Problem

An object of the present disclosure is to solve the above-mentioned problems and other problems.

An object of the present disclosure is to provide a display device capable of implementing three-dimensional and clear sound quality by minimizing sound interference with an audio device by outputting an input audio signal by bypassing it to an external audio device and upmixing an audio signal of a specific frequency band among the input audio signals into a virtual multi-channel audio signal and outputting it from the display device, and a method for processing audio signal thereof,

### Technical Solution

According to an embodiment of the present disclosure, a display device includes a communication part communicating with at least one external audio device; an audio output part outputting an audio signal; and, a processor controlling the communication part and the audio output part, in which the processor may control, when an original audio signal to be played is input, to output the original audio signal from the external audio device, to input an audio signal of a specific frequency band among the original audio signals to a pre-learned neural network model to upmix into a virtual multi-channel audio signal, and to output the upmixed virtual multi-channel audio signal from the audio output part.

According to an embodiment of the present disclosure, a method for processing an audio signal of a display device linked to an audio device may include checking input of an original audio signal to be played; controlling to output the original audio signal from the external audio device when the original audio signal is input; inputting an audio signal of a specific frequency band among the original audio signals into a pre-learned neural network model and upmixing the audio signal into a virtual multi-channel audio signal; and controlling the upmixed virtual multi-channel audio signal to be output from an audio output part of the display device.

### Advantageous Effect

According to one embodiment of the present disclosure, a display device can output an input audio signal by bypassing the audio signal to an external audio device, and upmixing an audio signal of a specific frequency band among the input audio signals into a virtual multi-channel audio signal and outputting the same from the display device, thereby minimizing sound interference with the audio device and implementing three-dimensional and clear sound quality.

### DESCRIPTION OF DRAWINGS

FIG. 1 is a block diagram illustrating a configuration of a display device according to an embodiment of the present disclosure.

FIG. 2 is a block diagram illustrating a remote control device according to an embodiment of the present disclosure.

FIG. 3 is a view illustrating an actual configuration of a remote control device according to an embodiment of the present disclosure.

FIG. 4 is a view illustrating an example of utilizing a remote control device according to an embodiment of the present disclosure.

FIG. 5 is a block diagram illustrating a display device connected to an external audio device according to one embodiment of the present disclosure.

FIG. 6 is a view for explaining an audio signal processing process of a display device according to an embodiment of the present disclosure.

FIGS. 7 to 11 are views for explaining an upmixing processing determination process according to one embodiment of the present disclosure.

FIG. 12 is a view for explaining an audio signal filtering process of a display device according to an embodiment of the present disclosure.

FIGS. 13 and 14 are views for explaining a HIGH-PASS filter selection process corresponding to an acoustic mode of a display device according to an embodiment of the present disclosure.

FIGS. 15 and 16 are views for explaining a HIGH-PASS filter selection process according to whether the sound mode of the display device is set according to an embodiment of the present disclosure.

FIG. 17 is a view for explaining a process of generating a virtual multi-channel audio signal of a display device according to an embodiment of the present disclosure.

FIGS. 18 and 19 are views for explaining an audio signal synchronization process between a display device and an external audio device according to one embodiment of the present disclosure.

FIG. 20 is a view for explaining an audio signal upmixing processing process of a display device and an external audio device according to one embodiment of the present disclosure.

FIG. 21 is a view for explaining an audio signal processing process of a display device according to an embodiment of the present disclosure.

### BEST MODEL

Hereinafter, embodiments disclosed in this specification is described with reference to the accompanying drawings, and the same or corresponding components are given with the same drawing number regardless of reference number, and their duplicated description will be omitted. The suffixes “module” and “part” for components used in the description below are assigned or mixed in consideration of easiness in writing the specification and do not have distinctive meanings or roles by themselves. Moreover, detailed descriptions related to well-known functions or configurations will be ruled out in order not to unnecessarily obscure subject matters of the present disclosure. However, this does not limit the present disclosure within specific embodiments and it should be understood that the present disclosure covers all the modifications, equivalents, and replacements within the idea and technical scope of the present disclosure.

It will be understood that although the ordinal numbers such as first and second are used herein to describe various elements, these elements should not be limited by these numbers. The terms are only used to distinguish one component from other components.

It will also be understood that when an element is referred to as being “‘connected to” or “engaged with” another element, it can be directly connected to the other element, or intervening elements can also be present. It will also be understood that when an element is referred to as being ‘directly connected to’ another element, there is no intervening elements.

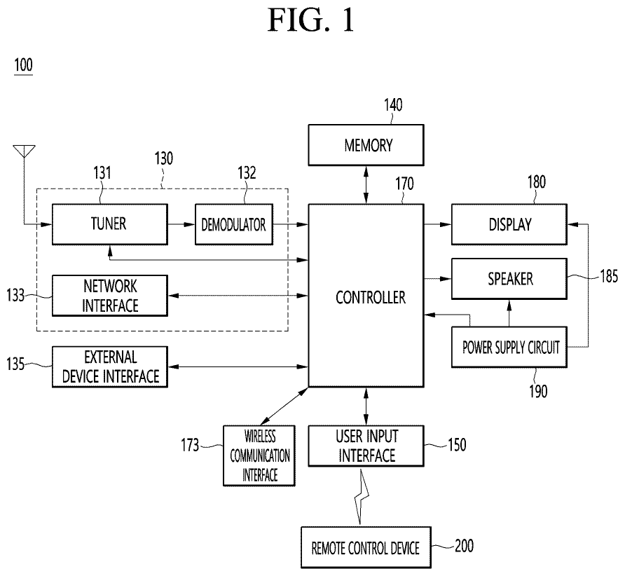

FIG. 1 is a block diagram illustrating a configuration of a display device according to an embodiment of the present disclosure.

Referring to FIG. 1, a display device 100 may include a broadcast reception module 130, an external device interface unit 135, a storage unit 140, a user input unit 150, a control unit 170, a wireless communication interface unit 173, a display unit 180, an audio output part 185, and a power supply unit 190.

The broadcast reception module 130 may include a tuner 131, a demodulator 132, and a network interface 133.

The tuner 131 may select a specific broadcast channel according to a channel selection command. The tuner 131 may receive broadcast signals for the selected specific broadcast channel.

The demodulation unit 132 may divide the received broadcast signals into video signals, audio signals, and broadcast program-related data signals, and may restore the divided video signals, audio signals, and data signals into an output available form.

The network interface 133 may provide an interface for connecting the display device 100 to a wired/wireless network comprising internet network. The network interface 133 may transmit or receive data to or from another user or another electronic device through an accessed network or another network linked to the accessed network.

The network interface unit 133 may access a predetermined webpage through an accessed network or another network linked to the accessed network. In other words, the network interface unit 133 may transmit or receive data to or from a corresponding server by accessing a predetermined webpage through the network.

The network interface unit 133 may receive content or data provided from a content provider or a network operator. In other words, the network interface unit 133 may receive content, such as movies, advertisements, games, VODs, and broadcast signals, which are provided from the content provider or the network operator, and information relating thereto through the network.

In addition, the network interface unit 133 may receive firmware update information and update files provided from the network operator, and may transmit data to the Internet or content provider or the network operator.

The network interface 133 may select and receive a desired application among applications open to the air, through network.

The external device interface unit 135 may receive an application or an application list in an adjacent external device and deliver the application or the application list to the control unit 170 or the storage unit 140.

The external device interface unit 135 may provide a connection path between the display device 100 and an external device. The external device interface unit 135 may receive at least one of an image or audio outputted from an external device that is wirelessly or wiredly connected to the display device 100 and deliver the received image or the audio to the controller. The external device interface unit 135 may include a plurality of external input terminals. The plurality of external input terminals may include an RGB terminal, at least one High Definition Multimedia Interface (HDMI) terminal, and a component terminal.

An image signal of an external device inputted through the external device interface unit 135 may be outputted through the display unit 180. A sound signal of an external device inputted through the external device interface unit 135 may be outputted through the audio output part 185.

An external device connectable to the external device interface unit 135 may be one of a set-top box, a Blu-ray player, a DVD player, a game console, a sound bar, a smartphone, a PC, a USB Memory, and a home theater system but this is just exemplary.

Additionally, some content data stored in the display device 100 may be transmitted to a user or an electronic device, which is selected from other users or other electronic devices pre-registered in the display device 100.

The storage unit 140 may store signal-processed image, voice, or data signals stored by a program in order for each signal processing and control in the control unit 170.

In addition, the storage unit 140 may perform a function for temporarily storing image, voice, or data signals output from the external device interface unit 135 or the network interface unit 133, and may store information on a predetermined image through a channel memory function.

The storage unit 140 may store an application or an application list input from the external device interface unit 135 or the network interface unit 133.

The display device 100 may play content files (e.g., video files, still image files, music files, document files, application files, etc.) stored in the storage unit 140, and may provide the content files to a user.

The user input unit 150 may transmit signals input by a user to the control unit 170, or may transmit signals from the control unit 170 to a user. For example, the user input unit 150 may receive or process control signals such as power on/off, channel selection, and screen setting from the remote control device 200 or transmit control signals from the control unit 170 to the remote control device 200 according to various communication methods such as Bluetooth, Ultra Wideband (WB), ZigBee, Radio Frequency (RF), and IR communication methods.

In addition, the user input unit 150 may transmit, to the control unit 170, control signals input from local keys (not illustrated) such as a power key, a channel key, a volume key, and a setting key.

Image signals that are image-processed by the control unit 170 may be input to the display unit 180 and displayed as images corresponding to the image signals. In addition, image signals that are image-processed by the control unit 170 may be input to an external output device through the external device interface unit 135.

Voice signals processed by the control unit 170 may be output to the audio output part 185. In addition, voice signals processed by the control unit 170 may be input to the external output device through the external device interface unit 135.

Additionally, the control unit 170 may control overall operations of the display device 100.

In addition, the control unit 170 may control the display device 100 by a user command or an internal program input through the user input unit 150, and may access the network to download a desired application or application list into the display device 100.

The control unit 170 may output channel information selected by a user together with the processed image or voice signals through the display unit 180 or the audio output part 185.

In addition, the control unit 170 may output image signals or voice signals of an external device such as a camera or a camcorder, which are input through the external device interface unit 135, through the display unit 180 or the audio output part 185, according to an external device image playback command received through the user input unit 150.

Moreover, the control unit 170 may control the display unit 180 to display images, and may control the display unit 180 to display broadcast images input through the tuner 131, external input images input through the external device interface unit 135, images input through the network interface unit, or images stored in the storage unit 140. In this case, an image displayed on the display unit 180 may be a still image or video and also may be a 2D image or a 3D image.

Additionally, the control unit 170 may play content stored in the display device 100, received broadcast content, and external input content input from the outside, and the content may be in various formats such as broadcast images, external input images, audio files, still images, accessed web screens, and document files.

Moreover, the wireless communication part 173 may perform wired or wireless communication with an external device. The wireless communication part 173 may perform short-range communication with an external device. For this, the wireless communication part 173 may support short-range communication by using at least one of Bluetooth™, Bluetooth Low Energy (BLE), Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies. The wireless communication part 173 may support wireless communication between the display device 100 and a wireless communication system, between the display device 100 and another display device 100, or between networks including the display device 100 and another display device 100 (or an external server) through wireless area networks. The wireless area networks may be wireless personal area networks.

Herein, the other display device 100 may be a mobile terminal such as a wearable device (for example, a smart watch, a smart glass, and a head mounted display (HMD)) or a smartphone, which is capable of exchanging data (or inter-working) with the display device 100. The wireless communication part 173 may detect (or recognize) a wearable device capable of communication around the display device 100. Furthermore, if the detected wearable device is a device authenticated to communicate with the display device 100, the control unit 170 may transmit at least part of data processed in the display device 100 to the wearable device through the wireless communication part 173. Therefore, a user of the wearable device may use the data processed by the display device 100 through the wearable device.

The voice acquisition unit 175 may acquire audio. The voice acquisition unit 175 may include at least one microphone (not illustrated) and may acquire audio around the display device 100 through the microphone (not illustrated).

The display unit 180 may convert image signals, data signals, or on-screen display (OSD) signals, which are processed in the control unit 170, or images signals or data signals, which are received in the external device interface unit 135, into R, G, and B signals to generate driving signals.

Furthermore, the display device 100 illustrated in FIG. 1 is just one embodiment of the present disclosure and thus, some of the components illustrated may be integrated, added, or omitted according to the specification of the actually implemented display device 100.

In other words, if necessary, two or more components may be integrated into one component, or one component may be divided into two or more components. Additionally, a function performed by each block is to describe an embodiment of the present disclosure and its specific operation or device does not limit the scope of the present disclosure.

According to another embodiment of the present disclosure, unlike FIG. 1, the display device 100 may receive images through the network interface unit 133 or the external device interface unit 135 and play them without including the tuner 131 and the demodulation unit 132.

For example, the display device 100 may be divided into an image processing device such as a set-top box for receiving broadcast signals or contents according to various network services and a content playback device for playing content input from the image processing device.

In this case, an operating method of a display device according to an embodiment of the present disclosure described below may be performed by one of the display device described with reference to FIG. 1, an image processing device such as the separated set-top box, and a content playback device including the display unit 180 and the audio output part 185.

The audio output part 185 receives the audio-processed signal from the control unit 170 to output an audio signal.

The power supply unit 190 supplies the corresponding power to the entire display device 100. Particularly, power may be supplied to the control unit 170 that is capable of being implemented in the form of a system on chip (SOC), the display unit 180 for displaying an image, the audio output part 185 for outputting audio, and the like.

Specifically, the power supply unit 190 may include a converter that converts AC power to DC power and a DC/DC converter that converts a level of the DC power.

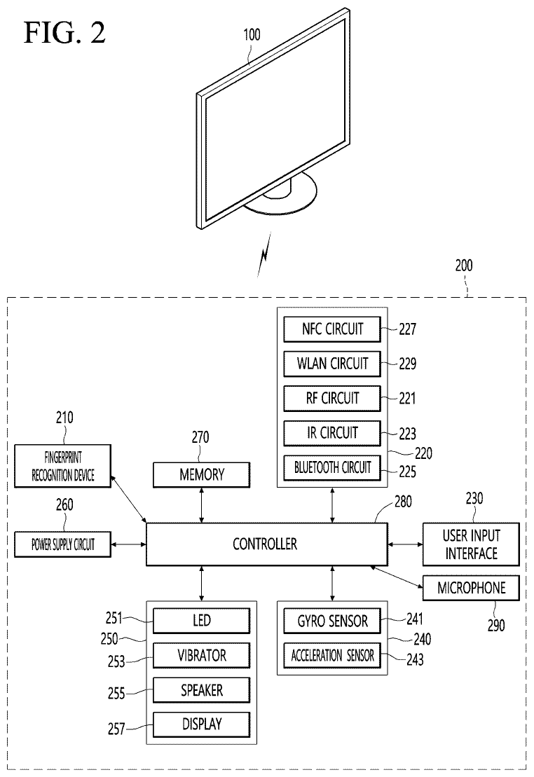

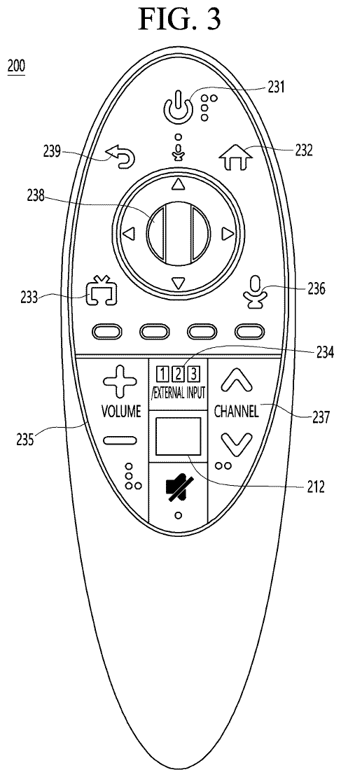

A remote control device according to an embodiment of the present disclosure will be described with reference to FIGS. 2 and 3.

FIG. 2 is a block diagram illustrating a remote control device according to an embodiment of the present disclosure and FIG. 3 is a view illustrating an actual configuration of a remote control device according to an embodiment of the present disclosure.

First, referring to FIG. 2, a remote control device 200 may include a fingerprint recognition unit 210, a wireless communication part 220, a user input unit 230, a sensor unit 240, an output part 250, a power supply unit 260, a storage unit 270, a control unit 280, and a sound acquisition unit 290.

Referring to FIG. 2, the wireless communication part 220 transmits/receives signals to/from an arbitrary any one of display devices according to the above-mentioned embodiments of the present disclosure.

The remote control device 200 may include a radio frequency (RF) module 221 capable of transmitting or receiving signals to or from the display device 100 according to an RF communication standard, and an IR module 223 capable of transmitting or receiving signals to or from the display device 100 according to an IR communication standard. In addition, the remote control device 200 may include a Bluetooth module 225 capable of transmitting or receiving signals to or from the display device 100 according to a Bluetooth communication standard. In addition, the remote control device 200 may include an NFC module 227 capable of transmitting or receiving signals to or from the display device 100 according to an NFC communication standard, and a wireless LAN (WLAN) module 229 capable of transmitting or receiving signals to or from the display device 100 according to a WLAN communication standard.

In addition, the remote control device 200 may transmit signals containing information on the movement of the remote control device 200 to the display device 100 through the wireless communication part 220.

Moreover, the remote control device 200 may receive signals transmitted from the display device 100 through the RF module 221 and if necessary, may transmit a command for power on/off, channel change, and volume change to the display device 100 through the IR module 223.

The user input unit 230 may be configured with a keypad, a button, a touch pad, or a touch screen. A user may operate the user input unit 230 to input a command relating to the display device 100 to the remote control device 200. If the user input unit 230 includes a hard key button, a user may input a command relating to the display device 100 to the remote control device 200 through the push operation of the hard key button. This will be described with reference to FIG. 3.

Referring to FIG. 3, the remote control device 200 may include a plurality of buttons. The plurality of buttons may include a fingerprint recognition button 212, a power button 231, a home button 232, a live button 233, an external input button 234, a volume control button 235, a voice recognition button 236, a channel change button 237, an OK button 238, and a back button 239.

The fingerprint recognition button 212 may be a button for recognizing a user's fingerprint. According to an embodiment of the present disclosure, the fingerprint recognition button 212 may perform a push operation and receive a push operation and a fingerprint recognition operation. The power button 231 may be a button for turning on/off the power of the display device 100. The home button 232 may be a button for moving to the home screen of the display device 100. The live button 233 may be a button for displaying live broadcast programs. The external input button 234 may be a button for receiving an external input connected to the display device 100. The volume control button 235 may be a button for controlling a volume output from the display device 100. The voice recognition button 236 may be a button for receiving user's voice and recognizing the received voice. The channel change button 237 may be a button for receiving broadcast signals of a specific broadcast channel. The OK button 238 may be a button for selecting a specific function, and the back button 239 may be a button for returning to a previous screen.

FIG. 2 is described again.

If the user input unit 230 includes a touch screen, a user may touch a soft key of the touch screen to input a command relating to the display device 100 to the remote control device 200. In addition, the user input unit 230 may include various kinds of input interfaces operable by a user, for example, a scroll key and a jog key, and this embodiment does not limit the scope of the present disclosure.

The sensor unit 240 may include a gyro sensor 241 or an acceleration sensor 243. The gyro sensor 241 may sense information on the movement of the remote control device 200.

For example, the gyro sensor 241 may sense information on an operation of the remote control device 200 on the basis of x, y, and z axes and the acceleration sensor 243 may sense information on a movement speed of the remote control device 200. Moreover, the remote control device 200 may further include a distance measurement sensor that senses a distance with respect to the display unit 180 of the display device 100.

The output part 250 may output image or voice signals in response to the operation of the user input unit 230, or may output image or voice signals corresponding to signals transmitted from the display device 100. A user may recognize whether the user input unit 230 is operated or the display device 100 is controlled through the output part 250.

For example, the output part 250 may include an LED module 251 for flashing, a vibration module 253 for generating vibration, a sound output module 255 for outputting sound, or a display module 257 for outputting an image, if the user input unit 230 is manipulated or signals are transmitted/received to/from the display device 100 through the wireless communication part 220.

Additionally, the power supply unit 260 supplies power to the remote control device 200 and if the remote control device 200 does not move for a predetermined time, stops the power supply, so that power waste may be reduced. The power supply unit 260 may resume the supply of power if a predetermined key provided at the remote control device 200 is operated.

The storage unit 270 may store various kinds of programs and application data required to control or operate the remote control device 200. If the remote control device 200 transmits/receives signals wirelessly through the display device 100 and the RF module 221, the remote control device 200 and the display device 100 transmits/receives signals through a predetermined frequency band.

The control unit 280 of the remote control device 200 may store, in the storage unit 270, information on a frequency band for transmitting/receiving signals to/from the display device 100 paired with the remote control device 200 and refer to it.

The control unit 280 controls general matters relating to the control of the remote control device 200. The control unit 280 may transmit a signal corresponding to a predetermined key operation of the user input unit 230 or a signal corresponding to the movement of the remote control device 200 sensed by the sensor unit 240 to the display device 100 through the wireless communication part 220.

In addition, the sound acquisition unit 290 of the remote control device 200 may acquire voice.

The sound acquisition unit 290 may include at least one microphone and acquire voice through the microphone.

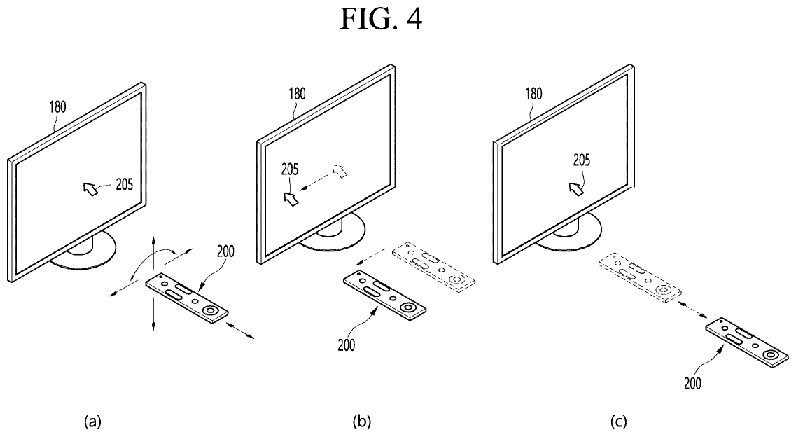

Next, FIG. 4 is described.

FIG. 4 is a view illustrating an example of utilizing a remote control device according to an embodiment of the present disclosure.

FIG. 4(a) illustrates that a pointer 205 corresponding to the remote control device 200 is displayed on the display unit 180.

A user may move or rotate the remote control device 200 vertically or horizontally. The pointer 205 displayed on the display unit 180 of the display device 100 corresponds to a movement of the remote control device 200. Since the corresponding pointer 205 is moved and displayed according to a movement on a 3D space as illustrated in the drawing, the remote control device 200 may be referred to as a spatial remote control device.

FIG. 4(b) illustrates that if a user moves the remote control device 200, the pointer 205 displayed on the display unit 180 of the display device 100 is moved to the left according to the movement of the remote control device 200.

Information on a movement of the remote control device 200 detected through a sensor of the remote control device 200 is transmitted to the display device 100. The display device 100 may calculate the coordinates of the pointer 205 from the information on the movement of the remote control device 200. The display device 100 may display the pointer 205 to match the calculated coordinates.

FIG. 4(c) illustrates that while a specific button in the remote control device 200 is pressed, a user moves the remote control device 200 away from the display unit 180. Thus, a selected region in the display unit 180 corresponding to the pointer 205 may be zoomed in and displayed in an enlarged size.

On the other hand, if a user moves the remote control device 200 close to the display unit 180, a selection area in the display unit 180 corresponding to the pointer 205 may be zoomed out and displayed in a reduced size.

On the other hand, if the remote control device 200 is moved away from the display unit 180, a selection area may be zoomed out and if the remote control device 200 is moved closer to the display unit 180, a selection area may be zoomed in.

Additionally, if a specific button in the remote control device 200 is pressed, recognition of a vertical or horizontal movement may be excluded. In other words, if the remote control device 200 is moved away from or closer to the display unit 180, the up, down, left, or right movement cannot be recognized and only the back and forth movement may be recognized. While a specific button in the remote control device 200 is not pressed, only the pointer 205 is moved according to the up, down, left or right movement of the remote control device 200.

Moreover, the moving speed or moving direction of the pointer 205 may correspond to the moving speed or moving direction of the remote control device 200.

Furthermore, a pointer in this specification means an object displayed on the display unit 180 in response to an operation of the remote control device 200. Therefore, in addition to the arrow form displayed as the pointer 205 in the drawing, various forms of objects are possible. For example, the above concept includes a point, a cursor, a prompt, and a thick outline. Then, the pointer 205 may be displayed in correspondence to one point of a horizontal axis and a vertical axis on the display unit 180 and also may be displayed in correspondence to a plurality of points such as a line and a surface.

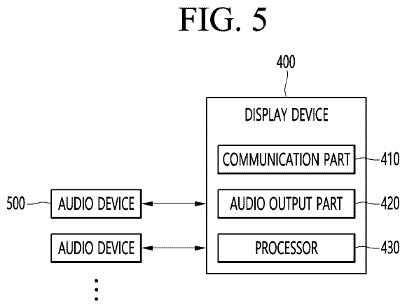

FIG. 5 is a block diagram illustrating a display device connected to an external audio device according to one embodiment of the present disclosure.

As illustrated in FIG. 5, the present disclosure may include a communication part 410 that communicates with at least one external audio device 500, an audio output part 420 that outputs an audio signal, and a processor 430 that controls the communication part 410 and the audio output part 420.

Here, the external audio device 500 can output sound through various channels including a surround speaker channel, a rear speaker channel, a front speaker channel, a center speaker channel, and a height speaker channel, such as a sound bar.

In addition, the processor 430 controls the output of the original audio signal from an external audio device 500 when an original audio signal to be played is input, inputs an audio signal of a specific frequency band among the original audio signals into a pre-learned neural network model to upmix the audio signal into a virtual multi-channel audio signal, and controls the output of the upmixed virtual multi-channel audio signal from the audio output part 420.

When determining up-mixing processing of an audio signal, the processor 430 checks whether the input original audio signal is a two-channel or multi-channel audio signal, and if the input original audio signal is a two-channel or multi-channel audio signal, can up-mix processing an audio signal of a specific frequency band among the original audio signal.

Here, the processor 430 may omit upmixing processing of the original audio signal if the input original audio signal is not a two-channel or multi-channel audio signal.

In some cases, when determining up-mixing processing of an audio signal, the processor 430 checks whether the input original audio signal is a two-channel or multi-channel audio signal, and if the input original audio signal is a two-channel or multi-channel audio signal, checks a user setting related to channel up-mixing, and if the user setting is a request for channel up-mixing, may up-mix an audio signal of a specific frequency band among the original audio signal.

Here, the processor 430 may omit upmixing processing of the original audio signal if the input original audio signal is not a two-channel or multi-channel audio signal.

Additionally, the processor 430 may omit upmixing processing of the original audio signal if the user setting is to reject channel upmixing.

In another case, when determining up-mixing processing of an audio signal, the processor 430 checks a preset audio output mode when an original audio signal to be played is input, and if the audio output mode is an audio simultaneous output mode in which an external audio device 500 and an audio output part 420 output audio simultaneously, the processor may up-mix processing an audio signal of a specific frequency band among the original audio signals.

Here, the processor 430 may omit upmixing processing of the original audio signal if the audio output mode is an audio single output mode in which an external audio device 500 or an audio output part 420 individually outputs audio.

In another case, when the processor 430 determines up-mixing processing of an audio signal, if an original audio signal to be played is input, the processor checks a preset audio output mode, and if the audio output mode is an audio simultaneous output mode in which an external audio device 500 and an audio output part 420 output audio simultaneously, the processor checks a user setting related to channel up-mixing, and if the user setting is a channel up-mixing request, the processor can up-mix an audio signal of a specific frequency band among the original audio signals.

Here, the processor 430 may omit upmixing processing of the original audio signal if the audio output mode is an audio single output mode in which an external audio device 500 or an audio output part 420 individually outputs audio.

Additionally, the processor 430 may omit upmixing processing of the original audio signal if the user setting is to reject channel upmixing.

In another case, when determining up-mixing processing of an audio signal, the processor 430 checks a preset audio output mode if an original audio signal to be played is input, and if the audio output mode is an audio simultaneous output mode in which an external audio device 500 and an audio output part 420 output audio simultaneously, the processor checks whether the input original audio signal is a 2-channel or multi-channel audio signal, and if the input original audio signal is a 2-channel or multi-channel audio signal, it checks a user setting related to channel up-mixing, and if the user setting is a channel up-mixing request, the processor can up-mix an audio signal of a specific frequency band among the original audio signals.

Here, the processor 430 may omit upmixing processing of the original audio signal if the audio output mode is an audio single output mode in which an external audio device 500 or an audio output part 420 individually outputs audio.

Additionally, the processor 430 may omit upmixing processing of the original audio signal if the input original audio signal is not a two-channel or multi-channel audio signal.

Additionally, the processor 430 may omit upmixing processing of the original audio signal if the user setting is to reject channel upmixing.

The original audio signal input to the display device 400 of the present disclosure may include, for example, at least one of UHD audio including Dolboy Atmos and DTS:X, HD audio, SD audio, and analog audio of stereo channels, but this is only an example and is not limited thereto.

Next, when upmixing an original audio signal, the processor 430 can filter the original audio signal to be played back to extract an audio signal of a specific frequency band, and input the extracted audio signal of the specific frequency band into a pre-learned neural network model to upmix the audio signal into a virtual multi-channel audio signal.

Here, the processor 430 can use a HIGH-PASS filter to remove audio signals in the low frequency band when filtering the original audio signal, and extract only audio signals in the mid and high frequency bands.

For example, when filtering an original audio signal, the processor 430 may use a HIGH-PASS filter to extract an audio signal in a frequency band of about 500 Hz to about 5 kHz.

Next, the processor 430 can check a preset sound mode when upmixing an original audio signal, obtain specific frequency band information corresponding to the preset sound mode, filter the original audio signal based on the specific frequency band information to extract an audio signal of a specific frequency band, and input the audio signal of the specific frequency band into a pre-learned neural network model to upmix the audio signal into a virtual multi-channel audio signal.

Here, when filtering an original audio signal, if the processor 430 obtains specific frequency band information corresponding to a preset sound mode, the processor selects a HIGH-PASS filter that passes only a specific frequency band corresponding to the preset sound mode among a plurality of HIGH-PASS filters, and uses the selected HIGH-PASS filter to remove audio signals in a low frequency band and extract only audio signals in a mid and high frequency band.

The plurality of HIGH-PASS filters may be at least one of a first HIGH-PASS filter that passes only a first frequency band, a second HIGH-PASS filter that passes only a second frequency band, a third HIGH-PASS filter that passes only a third frequency band, a fourth HIGH-PASS filter that passes only a fourth frequency band, a fifth HIGH-PASS filter that passes only a fifth frequency band, a sixth HIGH-PASS filter that passes only a sixth frequency band, and a seventh HIGH-PASS filter that passes only a seventh frequency band, but this is only one example and is not limited thereto.

For example, a first HIGH-PASS filter may pass only a frequency band of about 850 Hz to about 5 kHz, a second HIGH-PASS filter may pass only a frequency band of about 2 kHz to about 5 kHz, a third HIGH-PASS filter may pass only a frequency band of about 900 Hz to about 5 kHz, a fourth HIGH-PASS filter may pass only a frequency band of about 4 kHz to about 5 kHz, a fifth HIGH-PASS filter may pass only a frequency band of about 3 kHz to about 5 kHz, a sixth HIGH-PASS filter may pass only a frequency band of about 1 kHz to about 5 kHz, and a seventh HIGH-PASS filter may pass only a frequency band of about 1.5 kHz to about 5 kHz.

In addition, when selecting a HIGH-PASS filter, the processor 430 may select a first HIGH-PASS filter that passes only a first frequency band among a plurality of HIGH-PASS filters if the preset sound mode is an artificial intelligence sound mode, select a second HIGH-PASS filter that passes only a second frequency band among a plurality of HIGH-PASS filters if the preset sound mode is a standard sound mode, select a third HIGH-PASS filter that passes only a third frequency band among a plurality of HIGH-PASS filters if the preset sound mode is a movie sound mode, select a fourth HIGH-PASS filter that passes only a fourth frequency band among a plurality of HIGH-PASS filters if the preset sound mode is a clear voice sound mode, select a fifth HIGH-PASS filter that passes only a fifth frequency band among a plurality of HIGH-PASS filters if the preset sound mode is a music sound mode, select a sixth HIGH-PASS filter that passes only a sixth frequency band among a plurality of HIGH-PASS filters if the preset sound mode is a sports sound mode, and select a seventh HIGH-PASS filter that passes only a seventh frequency band among a plurality of HIGH-PASS filters if the preset sound mode is a game sound mode.

Next, when obtaining specific frequency band information corresponding to a preset sound mode, the processor 430 can obtain specific frequency band information corresponding to the preset sound mode from a first list table including audio frequency band information for each sound mode pre-stored in an external server or internal memory.

Additionally, when selecting a HIGH-PASS filter, the processor 430 may select a HIGH-PASS filter that passes only a specific frequency band corresponding to a preset sound mode from a second list table including pass frequency band information for each HIGH-PASS filter pre-stored in an external server or internal memory.

Next, the processor 430, when checking a preset sound mode, automatically selects a specific sound mode as default if the sound mode is not set, obtains specific frequency band information corresponding to the automatically selected sound mode, selects a HIGH-PASS filter that passes only a specific frequency band corresponding to the automatically selected sound mode among a plurality of HIGH-PASS filters, and uses the selected HIGH-PASS filter to remove audio signals in a low frequency band and extract only audio signals in a middle and high frequency band.

In some cases, when the processor 430 checks a preset sound mode, if the sound mode is not set, the processor 430 can generate a sound mode setting window requesting sound mode setting and displays it on a display screen, and when a user input for setting the sound mode is received through the sound mode setting window, the processor can obtain specific frequency band information corresponding to the set sound mode, select a HIGH-PASS filter that passes only a specific frequency band corresponding to the set sound mode among a plurality of HIGH-PASS filters, and remove audio signals of a low frequency band and extract only audio signals of a middle and high frequency band using the selected HIGH-PASS filter.

In addition, when upmixing an audio signal of a specific frequency band, the processor 430 can convert the audio signal of the specific frequency band into a time frequency band signal, extract a feature vector through main component analysis of the time frequency band signal, input the feature vector into a pre-learned neural network model to estimate an envelope of a main component signal and a sub-component signal of a multi-channel, and apply a weight to the estimated envelope to generate a virtual multi-channel audio signal.

Here, the processor 430 can convert an audio signal of a specific frequency band into a time-frequency band signal using a short-time Fourier transform (STFT) algorithm and a filter bank algorithm reflecting auditory characteristics.

As an example, the filter bank algorithm may include, but is not limited to, threshold bands based on auditory characteristics, octave bands, and ERB (Equivalent Rectangular Bandwidth) of gammatone.

In addition, when analyzing the main component, the processor 430 can analyze the main component separated into a main component that conveys main information including voice and audio objects through a time-frequency band signal and a subcomponent that expresses reverberation and a sense of space.

Here, the processor 430 can apply the separated main component to adjust panning in three-dimensional space to localize, improve clarity, and apply the separated sub-component to enhance the sound field effect that maximizes reverberation and spatial sense.

In addition, when extracting a feature vector, the processor 430 can extract a feature vector including panning gain, power of a main component, power of a subcomponent, signal size, correlation between channels, and phase information through main component analysis.

In addition, the processor 430 may calculate weights that minimize errors between main component signals and subcomponent signals of each target channel when applying weights to the estimated envelope, and apply the weights calculated for each target channel to the envelope of the corresponding channel to generate a virtual multi-channel audio signal having a natural output.

Next, when upmixing an audio signal of a specific frequency band, the processor 430 can upmix the audio signal into a virtual multi-channel audio signal having a different number of channels than the number of channels of the original audio signal output from the external audio device 500.

As an example, the processor 430 can upmix an audio signal of a specific frequency band into a virtual multi-channel audio signal having 9.1.2 channels, but this is only an example and is not limited thereto.

In some cases, when upmixing an audio signal of a specific frequency band, the processor 430 may upmix the audio signal into a virtual multi-channel audio signal having the same number of channels as the number of channels of the original audio signal output from the external audio device 500.

As an example, the processor 430 can upmix an audio signal of a specific frequency band into a virtual multi-channel audio signal having 9.1.5 channels, but this is only an example and is not limited thereto.

In addition, when outputting an upmixed virtual multi-channel audio signal, the processor 430 can obtain a first processing time of the virtual multi-channel audio signal output from the audio output part 420 and a second processing time of the original audio signal output from the external audio device 500, and synchronize the output of the virtual multi-channel audio signal and the output of the original audio signal of the external audio device 500 based on the first processing time and the second processing time.

Here, the processor 430 can obtain the first processing time of the virtual multi-channel audio signal from the internal memory and the second processing time of the original audio signal from the external audio device 500.

For example, the processor 430 may obtain a first processing time of a virtual multi-channel audio signal from an internal memory in which processing time information of a virtual multi-channel audio signal is pre-stored for each audio format, and may obtain a second processing time of an original audio signal from an external audio device 500 in which processing time information of an original audio signal and linkage information with a display device are pre-stored for each audio format.

Next, the processor 430 can control the output timing of the virtual multi-channel audio signal based on the first processing time and the second processing time to synchronize the output of the virtual multi-channel audio signal with the output of the original audio signal of the external audio device 500.

Here, the processor 430 can control the output timing of the virtual multi-channel audio signal to be delayed if the first processing time is faster than the second processing time, thereby synchronizing the output of the virtual multi-channel audio signal with the output of the original audio signal of the external audio device 500.

In some cases, the processor 430 may synchronize the output of the virtual multi-channel audio signal with the output of the original audio signal of the external audio device 500 by controlling the timing of transmission of the original audio signal to the external audio device 500 to be delayed if the first processing time is later than the second processing time.

Next, when the external audio device 500 receives an original audio signal, the external audio device inputs the original audio signal into a pre-learned neural network model to upmix the audio signal into a multi-channel audio signal, and outputs the upmixed multi-channel audio signal.

In addition, the processor 430 controls, when an original audio signal to be played is input, the original audio signal to be input the original audio signal to a first neural network model that has been pre-learned, to upmix it into a multi-channel audio signal, and to output the upmixed multi-channel audio signal from an external audio device 500. In addition, when an original audio signal to be played is input, the processor 430 controls, when an original audio signal to be played is input, the audio signal of a specific frequency band among the original audio signals to be input to a second neural network model that has been pre-learned, to upmix the audio signal into a virtual multi-channel audio signal, and to output the upmixed virtual multi-channel audio signal from an audio output part 420.

In this way, the present disclosure can minimize sound interference with the audio device and implement three-dimensional and clear sound quality by bypassing an input audio signal to an external audio device and outputting the input audio signal, and upmixing an audio signal of a specific frequency band among the input audio signals into a virtual multi-channel audio signal and outputting the same on a display device.

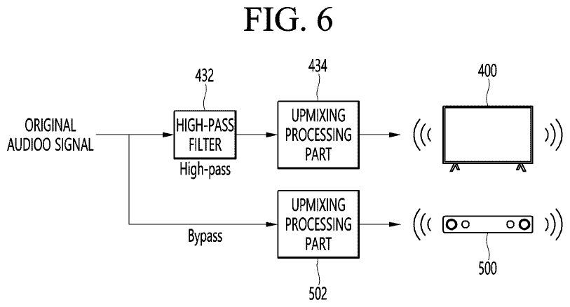

FIG. 6 is a view for explaining an audio signal processing process of a display device according to an embodiment of the present disclosure.

As illustrated in FIG. 6, the present disclosure can control, when an original audio signal to be played is input, the original audio signal to be output by bypassing the original audio signal to an external audio device 500, and the original audio signal to be output from a display device 400 through a HIGH-PASS filter 432.

Here, the external audio device 500 can upmix the original audio signal through the upmixing processing part 502 and output the original audio signal as a multi-channel audio signal.

In addition, the display device 400 can filter an original audio signal into an audio signal of a specific frequency band through a HIGH-PASS filter 432, and upmix the audio signal of a specific frequency band through an upmixing processing part 434 to output the audio signal as a virtual multi-channel audio signal.

For example, the original audio signal may include at least one of UHD audio, HD audio, SD audio, and analog audio in stereo channels, including Dolboy Atmos and DTS:X, but is not limited thereto.

Additionally, the HIGH-PASS filter 432 can remove audio signals in the low frequency band and extract only audio signals in the mid and high frequency bands.

For example, a HIGH-PASS filter 432 can extract an audio signal in a frequency band of about 500 Hz to about 5 kHz.

Next, the upmixing processing part 434 of the display device 400 can input audio signals of the mid- and high-frequency bands into a pre-learned neural network model and upmix them into a virtual multi-channel audio signal.

Here, the upmixing processing part 434 of the display device 400 can convert audio signals of mid- and high-frequency bands into time-frequency band signals, extract feature vectors through main component analysis of the time-frequency band signals, input the feature vectors into a pre-learned neural network model to estimate envelopes of main component signals and sub-component signals of multi-channels, and apply weights to the estimated envelopes to generate virtual multi-channel audio signals.

The upmixing processing part 434 of the display device 400 can upmix into a virtual multi-channel audio signal having a different number of channels than the number of channels of the original audio signal output from the external audio device 500.

For example, the upmixing processing part 434 of the display device 400 can upmix audio signals of the mid- and high-frequency bands into virtual multi-channel audio signals having 9.1.2 channels when the number of channels of the original audio signal output from the external audio device 500 is 9.1.5 channels, but this is only an example and is not limited thereto.

In some cases, the upmixing processing part 434 of the display device 400 may upmix into a virtual multi-channel audio signal having the same number of channels as the number of channels of the original audio signal output from the external audio device 500.

For example, the upmixing processing part 434 of the display device 400 can upmix audio signals of the mid- and high-frequency bands into virtual multi-channel audio signals having 9.1.5 channels when the number of channels of the original audio signal output from the external audio device 500 is 9.1.5 channels, but, this is only an example and is not limited thereto.

In this way, the present disclosure outputs mid-range and high-range audio signals by upmixing the mid-range and high-range audio signals into virtual multi-channel audio signals from a display device 400 and outputting original audio signals from an external audio device 500, thereby minimizing sound interference between the display device 400 and the external audio device 500, while enhancing spatial three-dimensionality and voice clarity.

In other words, since the sound of the low and mid-range bands played from multiple speakers is likely to cause sound interference such as volume amplification, cancellation, and echo in each frequency band even with a slight time difference, and the sound is discolored and the clarity of the sound is likely to deteriorate, the present disclosure can effectively avoid sound interference with an external audio device 500 such as a sound bar by playing only the mid-range and high-range sounds in multi-channel by applying a high-pass filter.

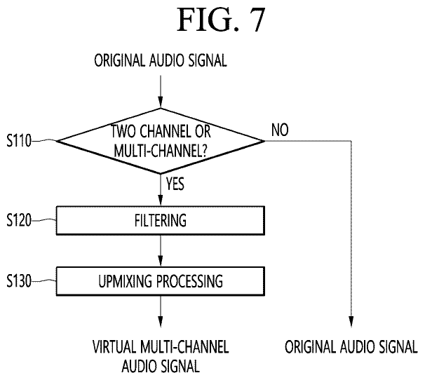

FIGS. 7 to 11 are views for explaining an upmixing processing determination process according to one embodiment of the present disclosure.

As illustrated in FIG. 7, the present disclosure can check whether an input original audio signal is a two-channel or multi-channel audio signal (S110).

Here, the present disclosure can omit upmixing processing of the original audio signal if the input original audio signal is not a two-channel or multi-channel audio signal.

In addition, in the present disclosure, if the input original audio signal is a two-channel or multi-channel audio signal, the original audio signal can be filtered into an audio signal of a specific frequency band (S120).

Here, in the original audio signal, the audio signal of the low frequency band can be removed through a high-pass filter and only audio signals of the mid and high frequency bands can be extracted.

Next, the present disclosure can upmix an audio signal of a specific frequency band and output the audio signal as a virtual multi-channel audio signal (S130).

Here, the present disclosure can upmix audio signals of mid- and high-frequency bands into virtual multi-channel audio signals by inputting the audio signals into a pre-learned neural network model.

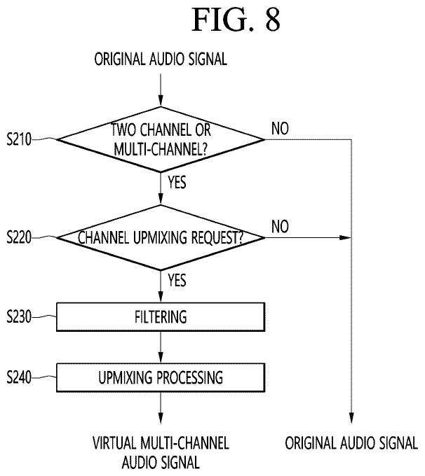

As another embodiment, as illustrated in FIG. 8, the present disclosure can check whether an input original audio signal is a two-channel or multi-channel audio signal (S210).

Here, the present disclosure can omit upmixing processing of the original audio signal if the input original audio signal is not a two-channel or multi-channel audio signal.

In addition, the present disclosure can check user settings related to channel upmixing if the input original audio signal is a 2-channel or multi-channel audio signal to check whether the user setting is a channel upmixing request (S220).

Here, the present disclosure can omit upmixing processing of the original audio signal if the user setting is to reject channel upmixing.

Next, the present disclosure can filter an original audio signal into an audio signal of a specific frequency band if the user setting is a channel upmixing request (S230).

Here, in the original audio signal, the audio signal of the low frequency band can be removed through a high-pass filter and only audio signals of the mid and high frequency bands can be extracted.

Next, the present disclosure can upmix an audio signal of a specific frequency band and output the audio signal as a virtual multi-channel audio signal (S240).

Here, the present disclosure can upmix audio signals of mid- and high-frequency bands into virtual multi-channel audio signals by inputting the audio signals into a pre-learned neural network model.

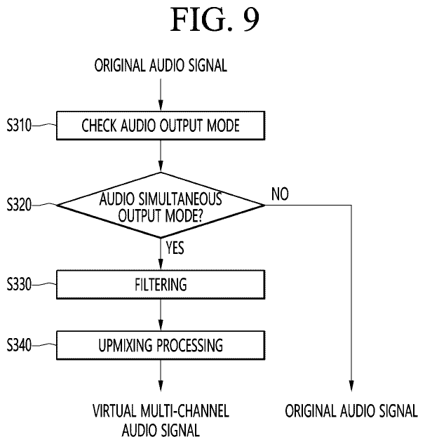

As another embodiment, as illustrated in FIG. 9, the present disclosure can check a preset audio output mode when an original audio signal to be played is input (S310).

In addition, the present disclosure can check whether the audio output mode is an audio simultaneous output mode in which an external audio device and an audio output part output audio simultaneously (S320).

Here, if the audio output mode is an audio single output mode that individually outputs audio from an external audio device or audio output part, upmixing processing of the original audio signal can be omitted.

Next, the present disclosure can filter an original audio signal among the original audio signals into an audio signal of a specific frequency band in the audio simultaneous output mode (S330).

Here, in the original audio signal, the audio signal of the low frequency band can be removed through a high-pass filter and only audio signals of the mid and high frequency bands can be extracted.

Next, the present disclosure can upmix an audio signal of a specific frequency band and output the audio signal as a virtual multi-channel audio signal (S340).

Here, the present disclosure can upmix audio signals of mid- and high-frequency bands into virtual multi-channel audio signals by inputting the audio signals into a pre-learned neural network model.

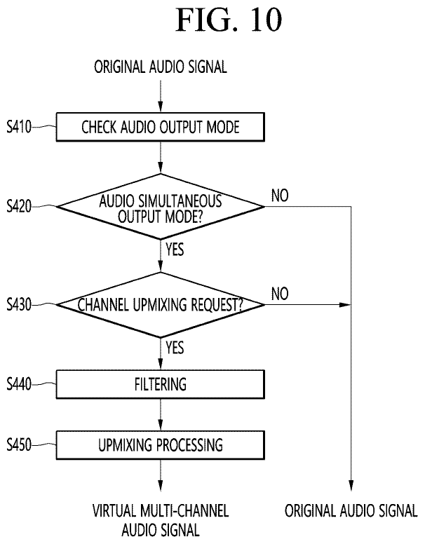

As another embodiment, as illustrated in FIG. 10, the present disclosure can check a preset audio output mode when an original audio signal to be played is input (S410).

In addition, the present disclosure can check whether the audio output mode is an audio simultaneous output mode in which an external audio device and an audio output part output audio simultaneously (S420).

Here, if the audio output mode is an audio single output mode that individually outputs audio from an external audio device or audio output part, upmixing processing of the original audio signal can be omitted.

Next, the present disclosure can check user settings related to channel upmixing in audio simultaneous output mode to check whether the user settings are a channel upmixing request (S430).

Here, the present disclosure can omit upmixing processing of the original audio signal if the user setting is to reject channel upmixing.

Next, the present disclosure can filter an original audio signal into an audio signal of a specific frequency band if the user setting is a channel upmixing request (S440).

Here, in the original audio signal, the audio signal of the low frequency band can be removed through a high-pass filter and only audio signals of the mid and high frequency bands can be extracted.

Next, the present disclosure can upmix an audio signal of a specific frequency band and output the audio signal as a virtual multi-channel audio signal (S450).

Here, the present disclosure can upmix audio signals of mid- and high-frequency bands into virtual multi-channel audio signals by inputting the audio signals into a pre-learned neural network model.

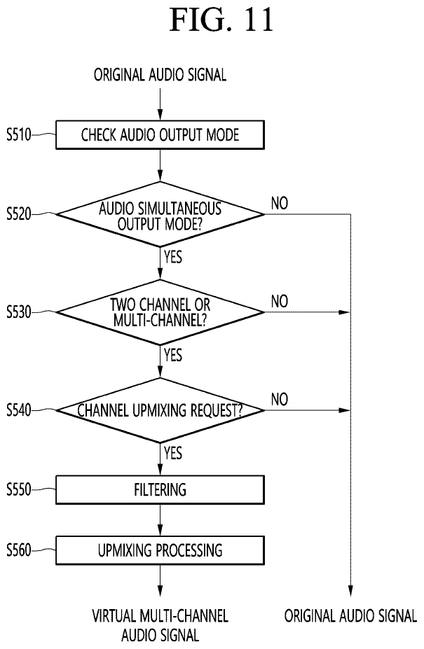

As another embodiment, as illustrated in FIG. 11, the present disclosure can check a preset audio output mode when an original audio signal to be played is input (S510).

In addition, the present disclosure can check whether the audio output mode is an audio simultaneous output mode in which an external audio device and an audio output part output audio simultaneously (S520).

Here, if the audio output mode is an audio single output mode that individually outputs audio from an external audio device or audio output part, upmixing processing of the original audio signal can be omitted.

Next, the present disclosure can check whether the input original audio signal is a 2-channel or multi-channel audio signal in the audio simultaneous output mode (S530).

Here, the present disclosure can omit upmixing processing of the original audio signal if the input original audio signal is not a two-channel or multi-channel audio signal.

Next, the present disclosure can check user settings related to channel upmixing if the input original audio signal is a two-channel or multi-channel audio signal to check whether the user settings are a channel upmixing request (S540).

Here, the present disclosure can omit upmixing processing of the original audio signal if the user setting is to reject channel upmixing.

Next, the present disclosure can filter an original audio signal into an audio signal of a specific frequency band if the user setting is a channel upmixing request (S550).

Here, in the original audio signal, the audio signal of the low frequency band can be removed through a high-pass filter and only audio signals of the mid and high frequency bands can be extracted.

Next, the present disclosure can upmix an audio signal of a specific frequency band and output the audio signal as a virtual multi-channel audio signal (S560).

Here, the present disclosure can upmix audio signals of mid- and high-frequency bands into virtual multi-channel audio signals by inputting the audio signals into a pre-learned neural network model.

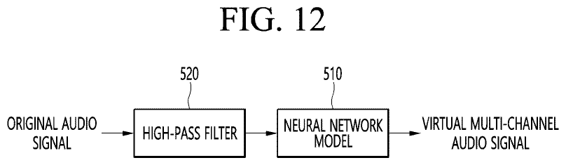

FIG. 12 is a view for explaining an audio signal filtering process of a display device according to an embodiment of the present disclosure.

As illustrated in FIG. 12, the display device of the present disclosure can extract an audio signal of a specific frequency band by filtering an original audio signal to be played when upmixing an original audio signal.

As an example, the present disclosure can remove audio signals in a low frequency band by using a HIGH-PASS filter 520 and extract only audio signals of mid- and high-frequency bands.

Here, the HIGH-PASS filter 520 can extract audio signals of the mid- and high-frequency bands, which are frequency bands of about 500 Hz to about 5 kHz.

This is because, when audio signals in the low-frequency band below about 500 Hz are output from a plurality of speakers, even a slight time difference can be perceived as audio discoloration and deterioration of clarity due to sound interference such as volume amplification, or cancellation, and echo in each band.

Accordingly, the present disclosure can effectively avoid sound interference with external audio devices such as a sound bar by removing a low-frequency band and reproducing audio in a mid-high frequency band by applying a high-pass filter 520 in a display device such as a TV.

In addition, the present disclosure can upmix an audio signal of a specific frequency band extracted through a HIGH-PASS filter 520 into a virtual multi-channel audio signal by inputting audio signal into a pre-learned neural network model 510.

Throughout this specification, the terms neural network, network function, and neural network may be used interchangeably.

The neural network model described above may be an artificial neural network (ANN) trained to output reconstructed data that is similar to the input data for the input data. An artificial neural network (ANN) is a model used in machine learning, and may refer to a model in general that has problem-solving capabilities and is composed of artificial neurons (nodes) that form a network by combining synapses.

For example, the neural network model may be an artificial neural network model based on an autoencoder. The neural network model based on an autoencoder may include, but is not limited to, an encoder part that reduces the dimensionality of data by making the number of neurons in the hidden layer smaller than the number of neurons in the input layer, and a decoder part that reconstructs the data by expanding the dimensionality of data from the hidden layer again, and has an output layer having the same number of neurons as the number of neurons in the input layer.

In addition, the neural network model may be an artificial neural network model based on a generative adversarial network (GAN). A generative adversarial network (GAN) may be an artificial neural network in which a generator and a discriminator are learned adversarially, but is not limited thereto.

In addition, the neural network model may be a deep neural network. A deep neural network (DNN) may refer to a neural network that includes a plurality of hidden layers in addition to an input layer and an output layer. Using a deep neural network, latent structures of data can be identified. In other words, latent structures of photos, text, videos, voices, and music (for example, what objects are in the photo, what the content and emotion of the text are, what the content and emotion of the voice are, or the like) can be identified. A deep neural network may include a convolutional neural network (CNN), a recurrent neural network (RNN), a restricted Boltzmann machine (RBM), a deep belief network (DBN), a Q network, a U network, a Siamese network, or the like.

In this way, the present disclosure can upmix an audio signal to be played into a virtual multi-channel audio signal using a neural network model.

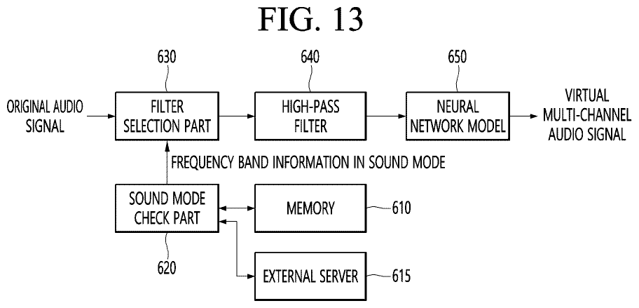

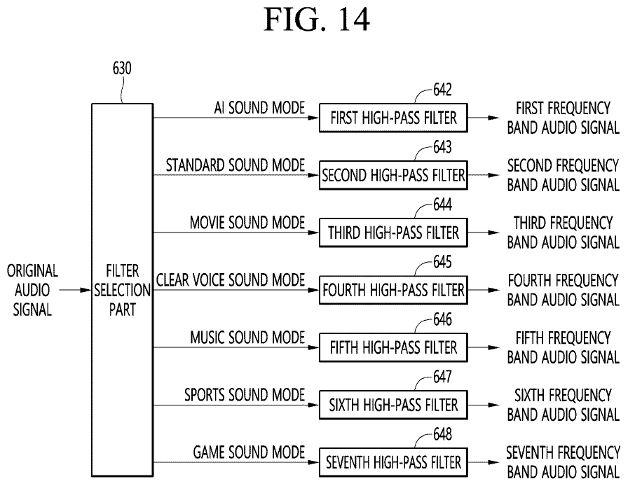

FIGS. 13 and 14 are views for explaining a HIGH-PASS filter selection process corresponding to an acoustic mode of a display device according to an embodiment of the present disclosure.

As illustrated in FIGS. 13 and 14, the present disclosure can identify a preset sound mode when upmixing an original audio signal, obtain specific frequency band information corresponding to the preset sound mode, filter the original audio signal based on the specific frequency band information to extract an audio signal of a specific frequency band, and input the audio signal of the specific frequency band into a pre-learned neural network model to upmix the audio signal into a virtual multi-channel audio signal.

In other words, the present disclosure performs filtering by selecting a filter corresponding to the currently set sound mode from among a plurality of filters based on the currently set sound mode, thereby upmixing an audio signal of a frequency band optimized for the currently set sound mode.

As illustrated in FIG. 13, the present disclosure can check the currently set sound mode through the sound mode check part 620 before upmixing the original audio signal.

Here, the sound mode check part 620 can obtain specific frequency band information corresponding to a preset sound mode.

For example, the sound mode check part 620 can obtain specific frequency band information corresponding to a preset sound mode from a first list table including audio frequency band information for each sound mode pre-stored in an external server 615 or internal memory 610.

In addition, the sound mode check part 620 can obtain HIGH-PASS filter information that passes only a specific frequency band corresponding to a preset sound mode from a second list table that includes pass frequency band information for each HIGH-PASS filter pre-stored in an external server 615 or internal memory 610.

Next, the sound mode check part 620 provides information on a specific frequency band of a preset sound mode to the filter selection part 630 and information on a HIGH-PASS filter that passes only a specific frequency band, and the filter selection part 630 can select a corresponding HIGH-PASS filter 640 among a plurality of HIGH-PASS filters based on the specific frequency band information and the HIGH-PASS filter information.

Next, the high-pass filter 640 selected by the filter selection part 630 can filter the original audio signal to extract an audio signal of a specific frequency band.

Here, the high-pass filter 640 can remove audio signals of the low-frequency band and extract only audio signals of the mid- and high-frequency bands.

Additionally, the pre-trained neural network model 650 can upmix audio signals of a specific frequency band into virtual multi-channel audio signals.

As illustrated in FIG. 14, the plurality of HIGH-PASS filters 640 may be at least one of a first HIGH-PASS filter 642 that passes only a first frequency band, a second HIGH-PASS filter 643 that passes only a second frequency band, a third HIGH-PASS filter 644 that passes only a third frequency band, a fourth HIGH-PASS filter 645 that passes only a fourth frequency band, a fifth HIGH-PASS filter 646 that passes only a fifth frequency band, a sixth HIGH-PASS filter 647 that passes only a sixth frequency band, and a seventh HIGH-PASS filter 648 that passes only a seventh frequency band, but this is only one example and is not limited thereto.

For example, the first HIGH-PASS filter 642 can pass only a frequency band of about 850Hz to about 5 kHz, the second HIGH-PASS filter 643 can pass only a frequency band of about 2 kHz to about 5 kHz, the third HIGH-PASS filter 644 can pass only a frequency band of about 900 Hz to about 5 kHz, the fourth HIGH-PASS filter 645 can pass only a frequency band of about 4 kHz to about 5 kHz, the fifth HIGH-PASS filter 646 can pass only a frequency band of about 3 kHz to about 5 kHz, the sixth HIGH-PASS filter 647 can pass only a frequency band of about 1 kHz to about 5 kHz, and the seventh HIGH-PASS filter 648 can pass only a frequency band of about 1.5 kHz to about 5 kHz.

In addition, the filter selection part 630, when selecting a HIGH-PASS filter, if the preset sound mode is an artificial intelligence sound mode, can select a first HIGH-PASS filter 642 that passes only the first frequency band among the plurality of HIGH-PASS filters, if the preset sound mode is a standard sound mode, select a second HIGH-PASS filter 643 that passes only the second frequency band among the plurality of HIGH-PASS filters, if the preset sound mode is a movie sound mode, select a third HIGH-PASS filter 644 that passes only the third frequency band among the plurality of HIGH-PASS filters, if the preset sound mode is a clear voice sound mode, select a fourth HIGH-PASS filter 645 that passes only the fourth frequency band among the plurality of HIGH-PASS filters, if the preset sound mode is a music sound mode, select a fifth HIGH-PASS filter 646 that passes only the fifth frequency band among the plurality of HIGH-PASS filters, if the preset sound mode is a sports sound mode, select a sixth HIGH-PASS filter 647 that passes only the sixth frequency band among the plurality of HIGH-PASS filters, and if the preset sound mode is a game sound mode, select a seventh HIGH-PASS filter 648 that passes only the seventh frequency band among a plurality of HIGH-PASS filters.

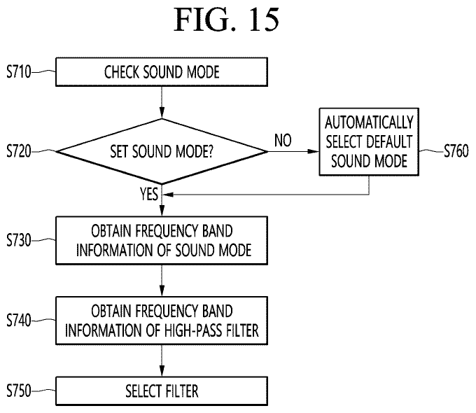

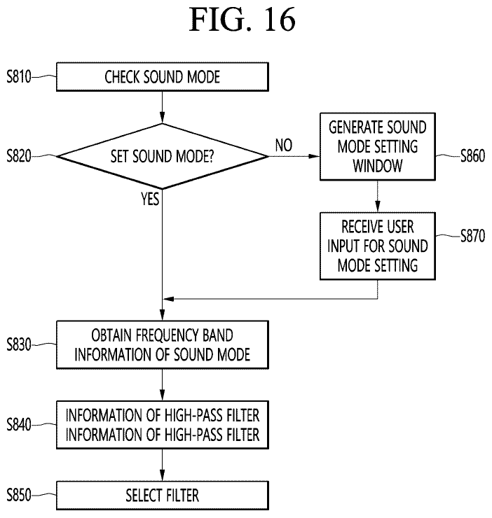

FIGS. 15 and 16 are views for explaining a HIGH-PASS filter selection process according to whether the sound mode of the display device is set according to an embodiment of the present disclosure.

As illustrated in FIG. 15, the present disclosure can check the sound mode (S710) and determine whether the sound mode is set (S720).

In addition, the present disclosure can automatically select a specific sound mode as default when the sound mode is not set (S760).

Next, the present disclosure can obtain specific frequency band information corresponding to an automatically selected sound mode (S730).

Next, the present disclosure can obtain frequency band information of a high-pass filter (S740).

In addition, the present disclosure can select a HIGH-PASS filter that passes only a specific frequency band corresponding to an automatically selected sound mode among a plurality of HIGH-PASS filters (S750).

In addition, the present disclosure can remove audio signals in a low frequency band by using a selected HIGH-PASS filter and extract only audio signals in a mid- and high-frequency band.

As another embodiment, as illustrated in FIG. 16, the present disclosure can determine whether the sound mode is set (S820) by checking the sound mode (S810).

In addition, the present disclosure can generate a sound mode setting window requesting sound mode setting when the sound mode is not set and display it the sound mode setting window the display screen (S860).

Next, the present disclosure can receive user input for setting a sound mode through a sound mode setting window (S870).

Next, the present disclosure can obtain specific frequency band information corresponding to the set sound mode when a user input for setting a sound mode is received through a sound mode setting window (S830).

In addition, the present disclosure can obtain frequency band information of a high-pass filter (S840).

Next, the present disclosure can select a HIGH-PASS filter that passes only a specific frequency band corresponding to a set sound mode among a plurality of HIGH-PASS filters (S850).

Next, the present disclosure can remove audio signals in a low frequency band by using a selected HIGH-PASS filter and extract only audio signals in a mid- and high-frequency band.

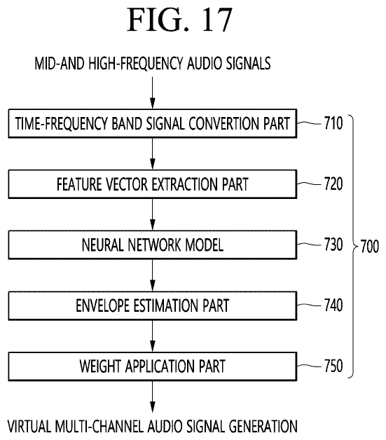

FIG. 17 is a view for explaining a process of generating a virtual multi-channel audio signal of a display device according to an embodiment of the present disclosure.

As illustrated in FIG. 17, the present disclosure can filter an original audio signal to be played to extract an audio signal of a specific frequency band, and input the extracted audio signal of the specific frequency band into a pre-learned neural network model to upmix the audio signal into a virtual multi-channel audio signal.

In the present disclosure, when an audio signal of a specific frequency band that has undergone a filtering process is an audio signal of a mid-range and high-range frequency band, the audio signal of the mid-range and high-range frequency band can be converted into a time-frequency band signal through a time-frequency band signal change part 710.

Here, the time-frequency band signal change part 710 can convert an audio signal of a specific frequency band into a time-frequency band signal using a short-time Fourier transform (STFT) algorithm and a filter bank algorithm reflecting auditory characteristics.

As an example, the filter bank algorithm may include, but is not limited to, threshold bands based on auditory characteristics, octave bands, and ERB (Equivalent Rectangular Bandwidth) of gammatone.

In addition, the present disclosure can extract a feature vector through main component analysis of a time frequency band signal via a feature vector extraction part 720.

Here, the feature vector extraction part 720 can analyze the separated main component by separating it into a main component that conveys main information including voice and audio objects through a time-frequency band signal and a subcomponent that expresses reverberation and a sense of space.

In this way, the present disclosure can improve the sound field effect by applying the separated main component to adjust panning in three-dimensional space, improve clarity, and maximize reverberation and spatial sense by applying the separated sub-component.

In addition, the feature vector extraction part 720 can extract a feature vector including panning gain, power of a main component, power of a subcomponent, signal size, correlation between channels, and phase information through main component analysis.

Next, the present disclosure can separate main component signals and subcomponent signals of multi-channels by inputting feature vectors into a pre-learned neural network model 730.

Next, the present disclosure can estimate the envelope of the main component signal and subcomponent signal of the multi-channel through the envelope estimation part 740.

In addition, the present disclosure can generate a virtual multi-channel audio signal by applying a weight to an envelope estimated through a weight application part 750.

Here, the weight application part 750 calculates a weight that minimizes the error between the main component signal and the subcomponent signal of each target channel, and applies the weight calculated for each target channel to the envelope of the corresponding channel to generate a virtual multi-channel audio signal having a natural output.

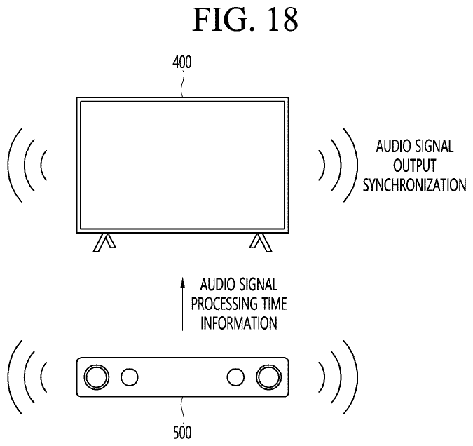

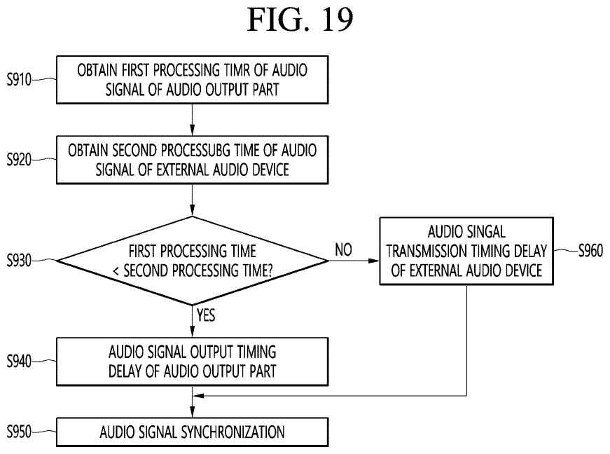

FIGS. 18 and 19 are views for explaining an audio signal synchronization process between a display device and an external audio device according to one embodiment of the present disclosure.

As illustrated in FIG. 18, the present disclosure can obtain a first processing time of a virtual multi-channel audio signal output from an audio output part of a display device 400 and a second processing time of an original audio signal output from an external audio device 500 when outputting an upmixed virtual multi-channel audio signal, and synchronize the output of the virtual multi-channel audio signal and the output of the original audio signal from the external audio device 500 based on the first processing time and the second processing time.

Here, the present disclosure can obtain a first processing time of a virtual multi-channel audio signal from an internal memory of a display device 400, and obtain a second processing time of an original audio signal from an external audio device 500.

For example, the present disclosure can obtain a first processing time of a virtual multi-channel audio signal from an internal memory in which processing time information of a virtual multi-channel audio signal is pre-stored for each audio format, and can obtain a second processing time of an original audio signal from an external audio device 500 in which processing time information of an original audio signal and linkage information with a display device 400 are pre-stored for each audio format.

In addition, the present disclosure can synchronize the output of the virtual multi-channel audio signal with the output of the original audio signal of the external audio device 500 by controlling the output timing of the virtual multi-channel audio signal based on the first processing time and the second processing time.

Here, the present disclosure can synchronize the output of the virtual multi-channel audio signal with the output of the original audio signal of the external audio device 500 by controlling the output timing of the virtual multi-channel audio signal to be delayed if the first processing time is faster than the second processing time.

In some cases, the present disclosure may synchronize the output of the virtual multi-channel audio signal with the output of the original audio signal of the external audio device 500 by controlling the timing of transmission of the original audio signal to the external audio device 500 to be delayed if the first processing time is later than the second processing time.

Next, when the external audio device 500 receives an original audio signal, the external audio device inputs the original audio signal into a pre-learned neural network model to upmix the original audio signal into a multi-channel audio signal, and outputs the upmixed multi-channel audio signal.

As illustrated in FIG. 19, the present disclosure can obtain a first processing time of a virtual multi-channel audio signal output from an audio output part of a display device (S910).

In addition, the present disclosure can obtain the second processing time of an original audio signal output from an external audio device (S920).

As an example, the present disclosure can obtain a first processing time of a virtual multi-channel audio signal from an internal memory, and obtain a second processing time of an original audio signal from an external audio device.

Next, the present disclosure can check whether the first processing time is faster than the second processing time (S930).

Next, the present disclosure can control the audio signal output timing of the audio output part to be delayed if the first processing time is faster than the second processing time (S940).

In addition, the present disclosure can control the timing of transmitting an original audio signal to an external audio device to be delayed if the first processing time is later than the second processing time (S960).

In addition, the present disclosure can synchronize the output of a virtual multi-channel audio signal of an audio output part and the output of an original audio signal of an external audio device (S950).

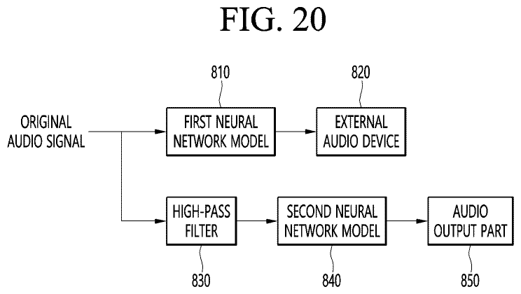

FIG. 20 is a view for explaining an audio signal upmixing processing process of a display device and an external audio device according to one embodiment of the present disclosure.

As illustrated in FIG. 20, the present disclosure can control, when an original audio signal to be played is input, the original audio signal is input to a pre-learned first neural network model 810 to upmix the original audio signal into a multi-channel audio signal, and the upmixed multi-channel audio signal is output from an external audio device 820.

In addition, in the present disclosure, when an original audio signal to be played is input, only an audio signal of a specific frequency band is extracted from the original audio signal through a high-pass filter 830, the audio signal of the specific frequency band is input to a pre-learned second neural network model 840 to be upmixed into a virtual multi-channel audio signal, and the upmixed virtual multi-channel audio signal can be controlled to be output from an audio output part 850 of a display device.

Here, in the present disclosure, when upmixing an audio signal of a specific frequency band on a display device, the audio signal can be upmixed into a virtual multi-channel audio signal having a different number of channels than the number of channels of the original audio signal output from the external audio device 820.

For example, the present disclosure can upmix an audio signal of a specific frequency band into a virtual multi-channel audio signal having 9.1.2 channels when the number of channels of an original audio signal output from an external audio device 820 is 9.1.5 channels, but this is only an example and is not limited thereto.

In some cases, the present disclosure may upmix an audio signal of a specific frequency band into a virtual multi-channel audio signal having the same number of channels as the number of channels of an original audio signal output from an external audio device 820.

For example, the present disclosure can upmix an audio signal of a specific frequency band into a virtual multi-channel audio signal having 9.1.5 channels when the number of channels of an original audio signal output from an external audio device 820 is 9.1.5 channels, but this is only an example and is not limited thereto.

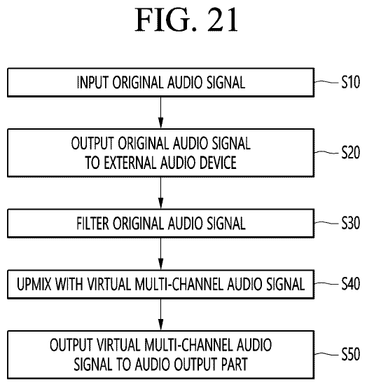

FIG. 21 is a view for explaining an audio signal processing process of a display device according to an embodiment of the present disclosure.

As illustrated in FIG. 21, the present disclosure can check the input of an original audio signal to be played (S10).

In addition, the present disclosure can control the output of an original audio signal from an external audio device when an original audio signal is input (S20).

Next, the present disclosure can filter an original audio signal to extract only an audio signal of a specific frequency band (S30).

Here, the present disclosure can remove audio signals in a low frequency band by using a HIGH-PASS filter, and extract only audio signals in a mid- and high-frequency band.

As an example, the present disclosure can extract an audio signal in a frequency band of about 500 Hz to about 5 kHz using a HIGH-PASS filter.

Next, the present disclosure can upmix an audio signal of a specific frequency band among original audio signals into a pre-learned neural network model to a virtual multi-channel audio signal (S40).

Here, the present disclosure converts an audio signal of a specific frequency band into a time-frequency band signal, extracts a feature vector through main component analysis of the time-frequency band signal, inputs the feature vector into the pre-learned neural network model to estimate envelopes of main component signals and subcomponent signals of multi-channels, and applies weights to the estimated envelopes to generate a virtual multi-channel audio signal.

In addition, the present disclosure can control the upmixed virtual multi-channel audio signal to be output from the audio output part of the display device (S50).

Here, the present disclosure can obtain a first processing time of a virtual multi-channel audio signal output from an audio output part and a second processing time of an original audio signal output from an external audio device, and synchronize the output of the virtual multi-channel audio signal and the output of the original audio signal from the external audio device based on the first processing time and the second processing time.

In this way, the present disclosure can minimize sound interference with the audio device and implement three-dimensional and clear sound quality by bypassing an input audio signal to an external audio device and outputting the input audio signal, and upmixing an audio signal of a specific frequency band among the input audio signals into a virtual multi-channel audio signal and outputting the audio signal on a display device.

The above-described present disclosure can be implemented as a computer-readable code on a medium in which a program is recorded. The computer-readable medium includes all kinds of recording devices in which data that can be read by a computer system is stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, and the like. In addition, the computer may include a processor 180 of an artificial intelligence device.

### INDUSTRIAL APPLICABILITY

According to the display device according to the present disclosure, by upmixing audio signals of a specific frequency band among input audio signals and outputting virtual multi-channel audio signals, it is possible to minimize sound interference with audio devices and implement three-dimensional and clear sound quality, so that the display device has remarkable industrial applicability.

1. A display device comprising:
a communication part communicating with at least one external audio device;
an audio output part outputting an audio signal; and,
a processor controlling the communication part and the audio output part,
wherein the processor controls,
when an original audio signal to be played is input, to output the original audio signal from the external audio device, to check a currently set sound mode, to obtain a specific frequency band information corresponding to the currently set sound mode from the specific frequency band information for each sound mode pre-stored, to select a filter passing only specific frequency band corresponding to the currently set sound mode, to filter only audio signal of the specific frequency band among the original audio signal, input an audio signal of the filtered specific frequency band to a pre-learned neural network model to upmix into a virtual multi-channel audio signal, and to output the upmixed virtual multi-channel audio signal from the audio output part.

2. The display device of claim 1,
wherein the processor,
when the original audio signal to be played is input, checks the preset audio output mode, and if the audio output mode is an audio simultaneous output mode in which the external audio device and the audio output part output audio simultaneously, upmixes the audio signal of a specific frequency band among the original audio signals.

3. The display device of claim 2,
wherein the processor,
when the audio output mode is an audio single output mode in which the external audio device or the audio output part individually outputs audio, omits upmixing processing of the original audio signal.

4. (canceled)

5. The display device of claim 1,
wherein the processor,
when filtering the original audio signal, uses a HIGH-PASS filter to remove audio signals in a low frequency band and extracts only audio signals in a mid and high frequency band.

6. (canceled)

7. The display device of claim 1,
wherein the processor,
when filtering the original audio signal, when obtaining specific frequency band information corresponding to the preset sound mode, selects a HIGH-PASS filter that passes only a specific frequency band corresponding to the preset sound mode among a plurality of HIGH-PASS filters, removes audio signals of a low frequency band using the selected HIGH-PASS filter, and extracts only audio signals of a mid- and high-frequency band.

8. The display device of claim 7,
wherein the processor,
when obtaining specific frequency band information corresponding to the preset sound mode, obtains specific frequency band information corresponding to the preset sound mode from a first list table including audio frequency band information for each sound mode pre-stored in an external server or internal memory.

9. The display device of claim 7,
wherein the processor,
when selecting the HIGH-PASS filter, selects a HIGH-PASS filter that passes only a specific frequency band corresponding to the preset sound mode from a second list table containing pass frequency band information for each HIGH-PASS filter pre-stored in an external server or internal memory.

10. The display device of claim 1,
wherein the processor,
when checking the preset sound mode, if the sound mode is not set, automatically selects a specific sound mode as default, obtains specific frequency band information corresponding to the automatically selected sound mode, selects a HIGH-PASS filter that passes only a specific frequency band corresponding to the automatically selected sound mode among a plurality of HIGH-PASS filters, and removes audio signals of a low frequency band using the selected HIGH-PASS filter and extracts only audio signals of a mid- and high-frequency band.

11. The display device of claim 1,
wherein the processor,
when checking the preset sound mode, if the sound mode is not set, generates a sound mode setting window requesting the sound mode setting and displays the sound mode setting window on the display screen, when a user input for setting the sound mode is received through the sound mode setting window, obtains specific frequency band information corresponding to the set sound mode, selects a HIGH-PASS filter that passes only a specific frequency band corresponding to the set sound mode among a plurality of HIGH-PASS filters, removes audio signals of a low frequency band using the selected HIGH-PASS filter, and extracts only audio signals of a mid- and high-frequency band.

12. The display device of claim 1,
wherein the processor,
when upmixing the audio signal of the specific frequency band, converts the audio signal of the specific frequency band into a time frequency band signal, extracts a feature vector through main component analysis of the time frequency band signal, inputs the feature vector into the pre-learned neural network model to estimate the envelope of the main component signal and the subcomponent signal of the multi-channel, and applies a weight to the estimated envelope to generate a virtual multi-channel audio signal.

13. The display device of claim 1,
wherein the processor,
when outputting the upmixed virtual multi-channel audio signal, obtains a first processing time of the virtual multi-channel audio signal output from the audio output part and a second processing time of the original audio signal output from the external audio device, and synchronizes the output of the virtual multi-channel audio signal and the output of the original audio signal of the external audio device based on the first processing time and the second processing time.

14. The display device of claim 13,
wherein the processor obtains the first processing time of the virtual multi-channel audio signal from the internal memory and obtains the second processing time of the original audio signal from the external audio device.

15. A method for processing an audio signal of a display device linked to an audio device, comprising:
checking input of an original audio signal to be played;
controlling to output the original audio signal from the external audio device when the original audio signal is input;
checking a currently set sound mode;
obtaining a specific frequency band information corresponding to the currently set sound mode from the specific frequency band information for each sound mode pre-stored;
selecting a filter passing only specific frequency band corresponding to the currently set sound mode;
filtering only audio signal of the specific frequency band among the original audio signal:
inputting an audio signal of the filtered specific frequency band into a pre-learned neural network model and upmixing the audio signal into a virtual multi-channel audio signal; and
controlling the upmixed virtual multi-channel audio signal to be output from an audio output part of the display device.
